(19) United States
(12) Patent Application Publication
(10) Pub. No.: US 2012/0136108 A1
(43) Pub. Date: May 31, 2012

(54) ONE-COMPONENT ORGANOPOLYSILOXANE COMPOSITIONS WITH HIGH RELATIVE PERMITTIVITY

(75) Inventors: Martin GRUNWALD, Emmerting (DE); Mathias MIEDL, Polling (DE)

(73) Assignee: WACKER CHEMIE AG, Muenchen (DE)

(21) Appl. No.: 13/294,702

(22) Filed: Nov. 11, 2011

(30) Foreign Application Priority Data
Nov. 29, 2010 (DE) 10 2010 062 139.0

(51) Int. Cl. C08K 3/04

(52) U.S. Cl. 524/495

(57) ABSTRACT

Organopolysiloxane composition (O) curable to vulcanizates having relative permittivity εᵣ of at least 6, measured by IEC 60250, and onset temperature greater than 80° C., including:
(A) 100 pbw of compounds having radicals with aliphatic carbon-carbon multiple bonds,
(B) 0.1-50 pbw of organopolysiloxanes with Si-bonded hydrogen atoms or, instead of (A) and (B),
(C) 100 pbw of organopolysiloxanes having SiC-bonded radicals with aliphatic carbon-carbon multiple bonds and Si-bonded hydrogen atoms,
(D) 10-100 pbw of mineral reinforcing filler with BET surface area of at least 50 m²/g by DIN-EN-ISO 9277,
(E) 4-300 pbw of carbon black with BET surface area of 5-1100 m²/g by ASTM D-6556 and with OAN of 10-500 ml/100 g by ASTM D-2414, and
(F) thermally activatable catalyst containing compounds of the platinum metals selected from Pt, Pa, Rh and Ru, in such an amount that 0.0000001-0.01 pbw of platinum metal is present in the organopolysiloxane composition (O).

### BACKGROUND OF THE INVENTION

The invention relates to organopolysiloxane compositions which comprise mineral reinforcing filler, carbon black and a thermally activatable catalyst.

Cable fittings are produced from elastomeric polymers typically in shaping processes such as injection molding or machine casting, or by means of extrusion. A standard process is the cold shrinkage of the cable fittings onto the cable ends. For this purpose, the elastomers must have good mechanical properties, such as high elongation at break, ultimate tensile strength and tear propagation resistance.

Extrudable silicone rubbers which have these properties are the one-component addition-crosslinking silicone compositions described in DE 19938338, which crosslink by reaction of aliphatically unsaturated groups with Si-bonded hydrogen (hydrosilylation) in the presence of a catalyst, typically of a platinum compound.

For the termination and connection of cables in the moderate- and high-voltage sector, field control in the fittings is required. This field control can be achieved, for example, in the form of refractive field control by a material with elevated relative permittivity. The relative permittivity required is not attained with the conventional silicone rubbers.

### DESCRIPTION OF THE INVENTION

The present invention provides organopolysiloxane compositions (O) which are curable to vulcanizates with a relative permittivity εᵣ of at least 6, measured to IEC 60250, and have an onset temperature of greater than 80° C., comprising

(A) 100 parts by weight of compounds having radicals with aliphatic carbon-carbon multiple bonds,

(B) 0.1 to 50 parts by weight of organopolysiloxanes with Si-bonded hydrogen atoms or, instead of (A) and (B),

(C) 100 parts by weight of organopolysiloxanes having

SiC-bonded radicals with aliphatic carbon-carbon multiple bonds and Si-bonded hydrogen atoms,

(D) 10 to 100 parts by weight of mineral reinforcing filler with a BET surface area of at least 50 m²/g to DIN EN ISO 9277,

(E) 4 to 300 parts by weight of carbon black with a BET surface area of 5 to 1100 m²/g to ASTM D 6556 and with an OAN of 10 to 500 ml/100 g to ASTM D 2414 and

(F) thermally activatable catalyst containing compounds of the platinum metals selected from Pt, Pa, Rh and Ru, in such an amount that 0.0000001 to 0.01 part by weight of platinum metal is present in the organopolysiloxane compositions (O).

The curable organopolysiloxane compositions (O) have, in the form of a one-component formulation, long pot lives of at least 4 weeks, especially at least 6 weeks, at 23° C. and ambient pressure. The organopolysiloxane compositions (O) preferably have pot lives of at least 1 week, especially at least 2 weeks, at 50° C. and ambient pressure.

The organopolysiloxane compositions (O) crosslink only at elevated temperature rapidly to give silicone rubbers with high relative permittivity coupled with low dielectric loss factor. The silicone rubbers have good mechanical properties, especially high elongation at break, ultimate tensile strength and tear propagation resistance.

As is well known, the compounds (A) and (B), or (C) used in the organopolysiloxane compositions (O) are selected such that crosslinking is possible. For example, compound (A) has at least two aliphatically unsaturated radicals and siloxane (B) at least three Si-bonded hydrogen atoms, or compound (A) has at least three aliphatically unsaturated radicals and siloxane (B) at least two Si-bonded hydrogen atoms, or else, instead of compounds (A) and (B), siloxane (C) which has aliphatically unsaturated radicals and Si-bonded hydrogen atoms in the abovementioned ratios is used.

Preferably, the organopolysiloxane compositions (O) comprise, as constituent (A), an aliphatically unsaturated organosilicon compound, it being possible to use all aliphatically unsaturated organosilicon compounds which have been used to date in addition-crosslinking compositions, and also, for example, silicone block copolymers with urea segments, silicone block copolymers with amide segments and/or imide segments and/or ester-amide segments and/or polystyrene segments and/or silarylene segments and/or carborane segments, and silicone graft copolymers with ether groups.

The organosilicon compounds (A) used, which have SiC-bonded radicals with aliphatic carbon-carbon multiple bonds, are preferably linear or branched organopolysiloxanes formed from units of the general formula I

RₐR¹_{b}SiO_{(4-a-b)/2} (I)

where

R is an organic radical free of aliphatic carbon-carbon multiple bonds,

R¹ is a monovalent, optionally substituted SiC-bonded hydrocarbyl radical with an aliphatic carbon-carbon multiple bond,

a is 0, 1, 2 or 3 and

b is 0, 1 or 2,

with the proviso that the sum of a+b is less than or equal to 3 and an average of at least 2 R¹ radicals are present per molecule.

The R radical may comprise mono- or polyvalent radicals, in which case the polyvalent radicals, such as bivalent, trivalent and tetravalent radicals, combine a plurality of, for instance two, three or four, siloxy units of the general formula (I).

R includes the monovalent radicals —F, —Cl, —Br, —OR⁶, —CN, —SCN, —NCO and SiC-bonded, optionally substituted hydrocarbyl radicals which may be interrupted by oxygen atoms or the —C(O)— group, and divalent radicals Si-bonded at both ends according to the general formula (I).

R⁶ may be a hydrogen atom or a monovalent, optionally substituted hydrocarbyl radical having 1 to 20 carbon atoms, preferably alkyl radicals and aryl radicals, particular preference being given to the hydrogen atom and the methyl and ethyl radicals.

If the R radical comprises SiC-bonded, substituted hydrocarbyl radicals, preferred substituents are halogen atoms, phosphorus-containing radicals, cyano radicals, —OR⁶, —NR⁶—, —NR⁶₂, —NR⁶—C(O) —NR⁶₂, —C (O)—NR⁶₂, —C(O)—R⁶, —C(O)OR⁶, —SO₂—Ph and —C₆F₅ where R⁶ is as defined above and Ph is a phenyl radical.

Examples of R radicals are alkyl radicals, such as the methyl, ethyl, n-propyl, isopropyl, n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals, aryl radicals such as the phenyl, naphthyl, anthryl and phenanthryl radical, alkaryl radicals such as o-, m-, p-tolyl radicals, xylyl radicals and ethylphenyl radicals, and aralkyl radicals such as the benzyl radical and the α- and β-phenylethyl radicals.

Examples of substituted R radicals are haloalkyl radicals such as the 3,3,3-trifluoro-n-propyl radical, the 2,2,2,2′,2′,2′-hexafluoroisopropyl radical, the heptafluoroisopropyl radical, haloaryl radicals such as the o-, m- and p-chlorophenyl radicals, —(CH₂)ₙ—N(R⁶)C(O)NR⁶₂, —(CH₂)ₙ—C(O)NR⁶₂, —(CH₂)ₙ—C(O)R⁶, —(CH₂)ₙ—C(O)OR⁶, —(CH₂)ₙ —C(O)NR⁶₂, —(CH₂)ₙ —C(O) —(CH₂)ₘ—C(O)CH₃, —(CH₂)ₙ—NR⁶—(CH₂)ₘ—NR⁶₂, —(CH₂)ₙ —O—CO—R⁶, —(CH₂) ₙ—O—(CH₂)ₘ—CH(OH)—CH₂OH, —(CH₂)ₙ—(OCH₂CH₂)ₘ—OR⁶, —(CH₂)ₙ—SO₂—Ph and —(CH₂)ₙ—O—C₆F₅, where R⁶ has a definition given above therefor, n and m are identical or different integers from 0 to 10 and Ph denotes the phenyl radical.

Examples of R as divalent radicals Si-bonded at both ends according to the general formula (I) are those which derive from the above monovalent examples given for the R radical in that an addition bond results from replacement of a hydrogen atom. Examples of such radicals are —(CH₂)ₙ—, —CH(CH₃)—, —C(CH₃)₂—, —CH(CH₃)—(CH₂)—, —C₆H₄, —CH(Ph)—CH₂—, —C(C^{F}₃)₂—, —(CH₂)ₙ—C₆H₄—(CH₂)ₙ—, —(CH₂)ₙ—C₆H₄—C₆H₄—(CH₂)ₙ, —(CH₂O)ₘ—, —(CH₂CH₂O)ₘ—, —(CH₂)ₙ—Oₓ—C₆H₄—SO₂—C₆H₄—Oₓ—(CH₂)ₙ—, where x is 0 or 1, m and n are each as defined above and Ph is the phenyl radical.

Preferably, the R radical is a monovalent SiC-bonded, optionally substituted hydrocarbyl radical which has 1 to 18 carbon atoms and is free of aliphatic carbon-carbon multiple bonds, more preferably a monovalent SiC-bonded hydrocarbyl radical which has 1 to 6 carbon atoms and is free of aliphatic carbon-carbon multiple bonds, especially the methyl or phenyl radical.

The R¹ radical may be any groups amenable to an addition reaction (hydrosilylation) with an SiH-functional compound.

If the R¹ radical comprises SiC-bonded substituted hydrocarbyl radicals, preferred substituents are halogen atoms, cyano radicals and —OR⁶ where R⁶ is as defined above.

The R¹ radical preferably comprises alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, particular preference being given to using vinyl, allyl and hexenyl radicals.

The molecular weight of constituent (A) may vary within wide limits, preferably from 10² to 10⁶ g/mol. For example, constituent (A) may be a relatively low molecular weight alkenyl-functional oligosiloxane, such as 1,2-divinyltetramethyldisiloxane, but also a high molecular weight polydimethylsiloxane possessing catenated or terminal Si-bonded vinyl groups, for example with a molecular weight of 10⁵ g/mol (number average determined by means of NMR). The structure of the molecules forming constituent (A) is also not fixed; more particularly, the structure of a high molecular weight, i.e. oligomeric or polymeric, siloxane may be linear, cyclic, branched or else resinous, network-like. Linear and cyclic polysiloxanes are preferably composed of units of the formulae R₃SiO_{1/2}, R¹R₂SiO_{1/2}, R¹RSiO_{2/2} and R₂SiO_{2/2}, where R and R¹ are each as defined above. Branched and network-like polysiloxanes additionally contain trifunctional and/or tetrafunctional units, preference being given to those of the formulae RSiO_{3/2}, R¹SiO_{3/2} and SiO_{4/2}. It will be appreciated that it is also possible to use mixtures of different siloxanes which meet the criteria of constituent (A).

Particular preference as component (A) is given to the use of vinyl-functional, essentially linear polydiorganosiloxanes with a viscosity of at least 0.01 Pa·s, preferably at least 0.1 Pa·s, and at most 500 000 Pa·s, preferably at most 100 000 Pa·s, in each case at 25° C.

The organosilicon compounds (B) used may be all hydrogen-functional organosilicon compounds which have also been used to date in addition-crosslinkable compositions.

The organopolysiloxanes (B) having Si-bonded hydrogen atoms used are preferably linear, cyclic or branched organopolysiloxanes formed from units of the general formula II

R¹⁰_{c}H_{d}SiO_{(4-c-d)/2} (II)

where

R¹⁰ is as defined for R,

c is 0, 1, 2 or 3 and

d is 0, 1 or 2,

with the proviso that the sum of c+d is less than or equal to 3 and an average of at least two Si-bonded hydrogen atoms are present per molecule.

The organopolysiloxane (B) preferably contains 0.04 to 1.7 percent by weight of Si-bonded hydrogen, based on the total weight of the organopolysiloxane (B).

The molecular weight of constituent (B) may likewise vary within wide limits, preferably from 10² to 10⁶ g/mol. For example, constituent (B) may be a relatively low molecular weight SiH-functional oligosiloxane, such as tetramethyldisiloxane, but also a high molecular weight polydimethylsiloxane possessing catenated or terminal SiH groups or a silicone resin having SiH groups. The structure of the molecules forming constituent (B) is also not fixed; more particularly, the structure of a high molecular weight, i.e. oligomeric or polymeric, SiH-containing siloxane may be linear, cyclic, branched, or else resinous, network-like. Linear and cyclic polysiloxanes are preferably composed of units of the formulae R¹⁰₃SiO_{1/2}, HR¹⁰₂SiO_{1/2}, HR¹⁰SiO_{2/2} and R¹⁰₂SiO_{2/2}. Branched and network-like polysiloxanes additionally contain trifunctional and/or tetrafunctional units, preference being given to those of the formulae R¹⁰SiO_{3/2}, HSiO_{3/2} and SiO_{4/2}. It will be appreciated that it is also possible to use mixtures of different siloxanes which satisfy the criteria of constituent (B). More particularly, the molecules forming constituent (B), in addition to the obligatory SiH groups, may optionally at the same time also contain aliphatically unsaturated groups. Particular preference is given to the use of low molecular weight SiH-functional compounds such as tetrakis(dimethylsiloxy)silane and tetramethylcyclo-tetrasiloxane, and of high molecular weight, SiH-containing siloxanes, such as poly(hydromethyl)siloxane and poly(dimethylhydromethyl)siloxane with a viscosity at 25° C. of 10 to 10 000 mPa·s, or analogous SiH-containing compounds in which some of the methyl groups have been replaced by 3,3,3-trifluoropropyl or phenyl groups.

Constituent (B) is preferably present in the organopolysiloxane compositions (O) in such an amount that the molar ratio of SiH groups to aliphatically unsaturated groups is 0.1 to 20, more preferably 1.0 to 5.0.

The curable organopolysiloxane compositions (O) preferably comprise at least 0.5 and especially at least 1 part by weight, and at most 20 and especially at most 10 parts by weight, of constituent (B).

Components (A) and (B) are commercial products or are preparable by processes standard in chemistry.

Instead of components (A) and (B), the organopolysiloxane compositions (O) may contain organopolysiloxanes (C) which have aliphatic carbon-carbon multiple bonds and Si-bonded hydrogen atoms, though this is not preferred.

If siloxanes (C) are used, they are preferably those formed from units of the general formulae

R¹¹_{g}SiO_{4-g/2}, R¹¹ₕR¹²SiO_{3-h/2} and R¹¹ᵢHSiO_{3-1/2},

where R¹¹ is as defined for R and R¹² is as defined for R¹,

g is 0, 1, 2 or 3,

h is 0, 1 or 2 and

i is 0, 1 or 2,

with the proviso that at least two R¹² radicals and at least 2 Si-bonded hydrogen atoms are present per molecule.

Examples of organopolysiloxanes (C) are those formed from SiO_{4/2}, R¹¹₃SiO_{1/2}, R¹¹₂R¹²SiO_{1/2} and R¹¹₂HSiO_{1/2} units, called MQ resins, where these resins may additionally contain R¹¹SiO_{3/2} and R¹¹₂SiO units, and linear organopolysiloxanes essentially consisting of R¹¹₂R¹²SiO_{1/2}, R¹¹₂SiO and R¹¹HSiO units where R¹¹ and R¹² are each as defined above.

The organopolysiloxanes (C) preferably have an average viscosity of at least 0.01 Pa·s, preferably at least 0.1 Pa·s, and at most 500 000 Pa·s, preferably at most 100 000 Pa·s, in each case at 25° C.

Organopolysiloxanes (C) are preparable by methods standard in chemistry.

Examples of mineral reinforcing fillers (D) are fumed or precipitated silicas and alumina, preference being given to fumed and precipitated silicas.

The silica fillers mentioned may have hydrophilic character or be hydrophobicized by known processes. When hydrophilic fillers are incorporated, the addition of a hydrophobicizing agent is required.

The mineral reinforcing filler (D) preferably has a BET surface area of at least 80 m²/g, especially at least 100 m²/g, to DIN EN ISO 9277.

The curable organopolysiloxane compositions (O) preferably contain at least 10 and especially at least 20 parts by weight, and at most 80 and especially at most 50 parts by weight, of filler (D).

The carbon black (E) may be one carbon black or a mixture of different carbon blacks. The carbon black (E) preferably has a BET surface area of at least 7 m²/g and at most 1000 m²/g, more preferably at most 950 m²/g, to ASTM D 6556. The OAN (Oil Adsorption Number) as a measure of the structure of the carbon black (E) is, for the individual carbon blacks, preferably at least 20 ml/100 g, especially at least 30 ml/100 g, and at most 400 ml/100 g, more preferably at most 200 ml/100 g, especially at most 50 ml/100 g, to ASTM D 2414.

The curable organopolysiloxane compositions (O) preferably contain at least 5 and especially at least 50 parts by weight, and at most 200 and especially at most 150 parts by weight, of carbon black (E).

The thermally activatable catalyst (F) preferably contains a platinum compound.

The onset temperature is preferably at least 100° C., especially at least 120° C., and at most 170° C., especially at most 150° C. The onset temperature of the organopolysiloxane compositions (O) is measured with a Gottfert Elastograph and is determined from a heating rate of 10° C/min. In this context, the temperature that corresponds to the 4% value of the maximum torque is defined as the onset temperature.

Preference is given to using catalysts (F) described in DE 19938338 A1, page 1 line 51 to page 4 line 24 and page 6 line 19 to page 7, and in DE 102007047212 A1, paragraphs [0042] to [0053].

The catalyst (F) preferably comprises bis(alkynyl) (1,5-cyclooctadiene)platinum, bis(alkynyl) (bicyclo[2.2.1]hepta-2,5-diene)platinum, bis(alkynyl) (1,5-dimethyl-1,5-cyclooctadiene)platinum and bis(alkynyl) (1,6-dimethyl-1,5-cyclooctadiene)platinum complexes, and compounds of the general formula (V)

R⁷₂Pt[P(OR⁸)₃]₂ (V)

where

R⁷ is halogen, mononegative inorganic radical, CR⁹₃, OR⁹, or SiR⁹₃,

R⁹ is alkyl of the formulae CₙH₂ₙ₊₁ where n=5−18 or CₘH₂ₘ₋₁ where m=5−31, arylalkyl of the formula —(C₆H₅₋ₚ)—(CₒH₂ₒ₊₁)ₚ where o=1−31 and p=1−5,

R⁹ is H, linear or branched aliphatic radicals having 1 to 18 carbon atoms or arylalkyl radicals having 6 to 31 carbon atoms,

where the hydrogen atoms of the R⁷ and R⁸ radicals are substituted or unsubstituted by the —NH₂, —COOH, —F, —Br, —Cl, -aryl or -alkyl groups.

Preferred R⁷ radicals are halogens, pseudohalogens and alkyl radicals. Preferred R⁸ radicals are alkyl radicals.

Preferably, the organopolysiloxane compositions (O) contain catalyst (F) in such an amount that at least 0.000005 and especially at least 0.000001 part by weight, and at most 0.0001 part by weight, of platinum metal is present therein. The amount of the catalyst (F) is guided by the desired crosslinking rate and the particular use, and economic factors. The organopolysiloxane compositions (O) contain catalysts (F) preferably in such amounts as to result in a platinum metal content of preferably 0.05 to 500 ppm by weight (=parts by weight per million parts by weight), more preferably 0.5 to 100 ppm by weight, especially 1 to 50 ppm by weight, based in each case on the total weight of the organopolysiloxane compositions (O).

Apart from components (A) to (F), the organopolysiloxane compositions (O) may also comprise any further substances which have also been used to date for production of addition-crosslinkable compositions.

The organopolysiloxane composition (O) may optionally contain, as constituent (G), further additions in a proportion of up to 70% by weight, preferably 0.0001 to 40% by weight. These additions may, for example, be inactive fillers, resinous organopolysiloxanes other than the organopolysiloxanes (A), (B) and (C), dispersing aids, solvents, adhesion promoters, pigments, dyes, plasticizers, organic polymers, heat stabilizers, etc. These include additions such as quartz flour, diatomaceous earth, clays, chalk, lithopone, graphite, metal oxides, metal carbonates or sulfates, metal salts of carboxylic acids, metal dusts, fibers such as glass fibers, polymer fibers, polymer powders, dyes and pigments.

It is additionally possible for additions (H) to be present, which serve for the controlled adjustment of processing time, onset temperature and crosslinking rate of the organopolysiloxane composition (O). These inhibitors and stabilizers are very well known in the field of addition-crosslinking compositions. Examples of common inhibitors are acetylenic alcohols such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular weight silicone oils with methylvinylSiO_{2/2} groups and/or R₂vinylSiO_{1/2} end groups, such as divinyltetramethyldisiloxane, tetravinyldimethyldisiloxane, trialkyl cyanurates, alkyl maleates such as diallyl maleate, dimethyl maleate and diethyl maleate, alkyl fumarates such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphines and phosphites, nitriles, triazoles, diaziridines and oximes. The effect of these inhibitor additions (H) depends on their chemical structure, and so it has to be determined individually.

The inhibitor content of the organopolysiloxane composition (O) is preferably 0 to 50 000 ppm, more preferably 20 to 2000 ppm, especially 100 to 1000 ppm.

The organopolysiloxane compositions (O) may, if required, be dissolved, dispersed, suspended or emulsified in liquids. The organopolysiloxane compositions (O) may—especially according to the viscosity of the constituents and filler content—be low in viscosity and castable, have a pasty consistency, be pulverulent, or else be conformable compositions of high viscosity, as is known to be the case for the compositions frequently referred to as RTV-1, RTV-2, LSR and HTV among specialists. More particularly, the organopolysiloxane compositions (O), if they are of high viscosity, can be provided in the form of granules. With regard to the elastomeric properties of the crosslinked organopolysiloxane composition (O), the entire spectrum is likewise encompassed, commencing from extremely soft silicone gels through rubber-like materials as far as highly crosslinked silicones with glasslike characteristics.

The organopolysiloxane compositions (O) can be prepared by known processes, for example by homogeneous mixing of the individual components. The sequence in this case is as desired, but it is preferable to homogeneously mix components (A) to (E), and to add the catalyst (F) to this mixture. The catalyst (F) can be incorporated as a solid substance or as a solution—dissolved in a suitable solvent—or in the form of a batch—mixed homogeneously with a small amount of (A) or (A) with (G).

Depending on the viscosity of (A), the mixing is effected, for example, with a stirrer, in a dissolver, on a roller or in a kneader. The catalyst (F) may also be encapsulated in an organic thermoplastic or thermoplastic silicone resin.

The components (A) to (H) used may each be a single kind of such a component, or else a mixture of at least two different kinds of one such component.

The organopolysiloxane compositions (O) can be crosslinked under the same conditions as the compositions known to date which are crosslinkable by hydrosilylation reaction.

The present invention further provides moldings produced by crosslinking the organopolysiloxane compositions (O).

The permittivity of the vulcanizate of the organopolysiloxane compositions (O) is preferably at least 7, especially at least 8, in each case measured to IEC 60250.

The specific volume resistivity of the vulcanizate is preferably at least 10¹⁰Ω cm, more preferably at least 10¹²Ω cm, especially at least 10¹⁴Ω cm, in each case measured to IEC 60093.

The dielectric loss factor of the vulcanizate is preferably at most tan δ 0.5, more preferably at most tan δ 0.15, especially at most tan δ 0.08, in each case measured to IEC 60250.

The organopolysiloxane compositions (O) and the crosslinking products produced therefrom can be used for all purposes for which organopolysiloxane compositions crosslinkable to elastomers or elastomers have also been used to date. This includes, for example, the silicone coating or impregnation of any desired substrates, the production of moldings, for example in an injection molding process, vacuum extrusion process, extrusion process, mold casting and compression molding, mold processing, and use as sealing, embedding and potting compounds. The organopolysiloxane compositions (O) are preferably used for moldings for the field control of cable fittings.

All above symbols in the above formulae are each defined independently of one another. In all formulae, the silicon atom is tetravalent.

In the examples described hereinafter, all parts and percentage figures, unless stated otherwise, are based on weight. Unless stated otherwise, the examples which follow are conducted at a pressure of the surrounding atmosphere, i.e. at about 1000 hPa, and at room temperature, i.e. at about 23° C., or a temperature which is established when the reactants are combined at room temperature without additional heating or cooling. COD means cycloocta-1,5-diene.

Relative permittivities were measured to IEC 60250.

Dielectric loss factor was measured to IEC 60250.

The BET surface areas of the carbon black are based on ASTM D 6556.

The BET surface areas of the silica are based on DIN EN ISO 9277.

The OANs are based on ASTM D 2414.

Shore A hardness was measured to ISO 868.

Elongation at break was measured to ISO 37.

Ultimate tensile strength was measured to ISO 37.

Tear propagation resistance was measured to ASTM D 624 B.

Specific volume resistivity was determined to IEC 60093.

The storage stability reported reports the time taken for the viscosity of the composition to double.

### EXAMPLE 1

### Preparation of Premixture A

In a kneader, 33 parts of a vinyldimethylsiloxy-terminated polydimethylsiloxane with a molecular weight of approx. 500 000 g/mol were admixed with 0.5 part water, 1.3 parts hexamethyldisilazane and 7 parts of a fumed silica with a specific surface area of 150 m²/g, and mixed homogeneously. The mixture was then heated to 150° C. After a wait time of 90 minutes, 0.5 part of a terminally OH-functional siloxane was added and, after a further 20 minutes, 4 parts of a fumed silica with a surface area of 200 m²/g were added. After a wait time of 90 minutes, the kneader temperature was lowered again to 25° C.

To 44 parts of premixture A were added, in a kneader, 35 parts of carbon black with a BET surface area to ASTM D 6556 of 7 to 12 m²/g and an OAN to ASTM D 2414 of 35 to 40 ml/100 g, 20 parts of a vinyldimethylsiloxy-terminated polydimethylsiloxane with a molecular weight of approx. 500 000 g/mol and, as an SiH crosslinker, 1.2 parts of a copolymer composed of dimethylsiloxy and methylhydrosiloxy and trimethylsiloxy units with a viscosity of 300—500 mPa·s at 25° C. and a content of Si-bonded hydrogen of 0.46% by weight, and the mixture was mixed.

To this were added, on a roll, 2 parts of a catalyst batch containing 940 ppm of a platinum complex of the following formula:

[ (COD)Pt(p-C≡C—C₆H₄—SiMe₃)₂]

and 2 parts of an inhibitor batch of 10% ethynylcyclohexanol dissolved in a vinyldimethylsiloxy-terminated polydimethylsiloxane.

### EXAMPLE 2

Instead of the catalyst from Example 1, the catalyst used was 1 part of a catalyst batch which contained 500 ppm of (PtCl₂[(P(O-2-tert-butylphenyl)₃]₂ and, as an inhibitor, 0.1 part of the inhibitor batch described in Example 1.

### EXAMPLE 3

### Preparation of Premixture B

To 69 parts of premixture A were added, in a kneader, 10 parts of a carbon black with a BET surface area of 910 m²/g and an OAN of 380 ml/100 g and 20 parts of a vinyldimethylsiloxy-terminated polydimethylsiloxane with a molecular weight of approx. 500 000 g/mol and, as an SiH crosslinker, 1.2 parts of a copolymer composed of dimethylsiloxy and methylhydrosiloxy and trimethylsiloxy units with a viscosity of 300—500 mPa·s at 25° C. and a content of Si-bonded hydrogen of 0.46% by weight, and the mixture was mixed.

30 parts of premixture B were then mixed with 68 parts of a mixture consisting of 100 parts of premixture A, 1.1 parts of the Si—H crosslinker described in Example and 0.35 part of the inhibitor batch described in Example 1, and then admixed on a roller with 2 parts of the catalyst batch described in Example 1 and 1 part of the inhibitor batch described in Example 1.

### Properties

### Example 1

Relative permittivity εᵣ: 10

Dielectric loss factor tan δ: 0.05

Specific volume resistivity: 1.10×10¹⁵Ω cm

Shore A hardness: 36

Elongation at break: 600%

Ultimate tensile strength: 5 MPa

Tear propagation resistance: 25 N/mm

Storage stability at 50° C.: >2 weeks Onset temperature after storage at 50° C. for 2 weeks: 130° C.

### Example 2

Mechanical and electrical properties as for Example 1

Storage stability at 50° C.: >2 weeks

Onset temperature after storage at 50° C. for 2 weeks: 140° C.

### Example 3

Relative permittivity εᵣ: 9

Dielectric loss factor tan δ: 0.03

Specific volume resistivity: 1.04×10¹⁵Ω cm

Shore A hardness: 35

Elongation at break: 690%

Ultimate tensile strength: 5 MPa

Tear propagation resistance: 25 N/mm

1. An organopolysiloxane composition (O) which is curable to vulcanizates having a relative permittivity εᵣ of at least 6, measured according to IEC 60250, and has an onset temperature greater than 80° C., comprising:
(A) 100 parts by weight of compounds having radicals with aliphatic carbon-carbon multiple bonds, and
(B) 0.1 to 50 parts by weight of organopolysiloxanes with Si-bonded hydrogen atoms or, instead of (A) and (B),
(C) 100 parts by weight of organopolysiloxanes having SiC-bonded radicals with aliphatic carbon-carbon multiple bonds and Si-bonded hydrogen atoms,
and further comprises:
(D) 10 to 100 parts by weight of mineral reinforcing filler with a BET surface area of at least 50 m²/g to DIN EN ISO 9277, (E) 4 to 300 parts by weight of carbon black with a BET surface area of 5 to 1100 m²/g to ASTM D 6556 and with an OAN of 10 to 500 ml/100 g to ASTM D 2414 and
(F) thermally activatable catalyst containing compounds of the platinum metals selected from Pt, Pa, Rh and Ru, in such an amount that 0.0000001 to 0.01 part by weight of platinum metal is present in the organopolysiloxane composition (O).

2. The curable organopolysiloxane composition (O) as claimed in claim 1, in which the aliphatically unsaturated organosilicon compound (A), organosilicon compounds are organopolysiloxanes formed from units of the general formula I
RₐR¹_{b}SiO_{(4-a-b})/2 (I)
where
R is an organic radical free of aliphatic carbon-carbon multiple bonds,
R¹ is a monovalent, optionally substituted SiC-bonded hydrocarbyl radical with an aliphatic carbon-carbon multiple bond,
a is 0, 1, 2 or 3 and
b is 0, 1 or 2,
with the proviso that a sum of a+b is less than or equal to 3 and an average of at least 2 R¹ radicals are present per molecule.

3. The curable organopolysiloxane composition (O) as claimed in claim 1, in which the organopolysiloxanes (B) are organopolysiloxanes formed from units of the general formula II
R¹⁰_{c}H_{d}SiO_{(4-c-d)/2} (II)
where
R¹⁰ is as defined for R,
c is 0, 1, 2 or 3 and
d is 0, 1 or 2,
with the proviso that a sum of c+d is less than or equal to 3 and an average of at least two Si-bonded hydrogen atoms are present per molecule.

4. The curable organopolysiloxane composition (O) as claimed in claim 1, in which the mineral reinforcing fillers (D) are selected from the group consisting of fumed or precipitated silicas and alumina.

5. The curable organopolysiloxane composition (O) as claimed in claim 1, in which the 0AN of the carbon black (E) is at least 20 ml/100 g according to ASTM D 2414.

6. The curable organopolysiloxane composition (O) as claimed in claim 1, in which the catalyst (F) comprises a platinum compound.

7. The curable organopolysiloxane composition (O) as claimed in claim 1, in which a dielectric loss factor tan δ of the vulcanizate is at most 0.15 according to IEC 60250.

8. The curable organopolysiloxane composition (O) as claimed in claim 2, in which the organopolysiloxanes (B) are organopolysiloxanes formed from units of the general formula II
R¹⁰_{c}H_{d}SiO_{(4-c-d)/2} (II)
where
R¹⁰ is as defined for R,
c is 0, 1, 2 or 3 and
d is 0, 1 or 2,
with the proviso that a sum of c+d is less than or equal to 3 and an average of at least two Si-bonded hydrogen atoms are present per molecule.

9. The curable organopolysiloxane composition (O) as claimed in claim 8, in which the mineral reinforcing fillers (D) are selected from the group consisting of fumed or precipitated silicas and alumina.

10. The curable organopolysiloxane composition (O) as claimed in claim 9, in which the OAN of the carbon black (E) is at least 20 ml/100 g according to ASTM D 2414.

11. The curable organopolysiloxane composition (O) as claimed in claim 10, in which the catalyst (F) comprises a platinum compound.

12. The curable organopolysiloxane composition (O) as claimed in claim 11, in which a dielectric loss factor tan δ of the vulcanizate is at most 0.15 according to IEC 60250.
